(19) United States
(12) Patent Application Publication
(10) Pub. No.: US 2011/0277734 A1
(43) Pub. Date: Nov. 17, 2011

(54) CATALYTIC FUEL OXIDATION SYSTEM USING EXHAUST GAS

(76) Inventor: David M. McCANN, Los Angeles, CA (US)

(21) Appl. No.: 12/778,001

(22) Filed: May 11, 2010

(51) Int. Cl. F02B 23/00

(52) U.S. Cl. 123/585

(57) ABSTRACT

A fuel system for an automotive engine is provided that includes a catalytic reactor that is configured to partially oxidize a portion of hydrocarbons in a hydrocarbon based fuel to create a fuel that is more compression ignitable. Exhaust gas is diverted from the exhaust system of an automobile and mixed with a hydrocarbon fuel. The fuel/exhaust gas mixture is exposed to an oxidizing catalyst such that at least a portion of the hydrocarbon fuel is partially oxidized. The resultant fuel mixture is metered into a compression ignition engine for engine operation.

### TECHNICAL FIELD

The present invention relates generally to automotive fuel systems, and more particularly, some embodiments relate to lowering the octane rating of standard automotive fuel for use in a compression ignition engine.

### DESCRIPTION OF THE RELATED ART

Compression ignition engines can potentially greatly improve the efficiency and emissions of gasoline fueled engines. In compression ignition engines, fuel injected into the engine combustion chamber auto-ignites when subjected to sufficient pressure and temperature. Operation of compression ignition engines, particularly homogeneous charge compression ignition (IICCI) engines, benefits from precise control over ignition characteristics of the fuel used.

Hydrocarbon based fuels, such as gasoline or diesel, comprise mixtures of many different types of hydrocarbons. For example, gasoline may comprise saturated hydrocarbons such as paraffins (alkanes) and unsaturated hydrocarbons such as olefins (alkenes) or aromatics. The final composition of a hydrocarbon fuel is often dependent on the process used to form it. For example, petroleum refining employing catalytic cracking typically produces large amounts of alkenes, while catalytic reforming typically produces large amounts of aromatics. These fuels also typically include various additives, such as oxygenates.

Different factors affect the compression ignition of hydrocarbons. Chain length, branching and unsaturation of the hydrocarbon lead to different compression ignite characteristics. For example, highly branched, aromatic, cyclic, or other unsaturated hydrocarbons are typically less susceptible to compression ignition than straight chain paraffins, such as iso-octane, toluene, or methylcyclohexane. Alternatively, longer unbranched hydrocarbons, such as n-decane, n-dodecane and n-hexadecane (diesel type molecules), tend to autoignite at lower temperatures.

To reduce engine emissions of certain pollutants such as carbon monoxide, many jurisdictions require the addition of oxygenates into gasoline. Methyl tert-butyl ether (MTBE) was the most common oxygenate added to gasoline to meet these requirements. However, due to health concerns, it is being increasingly phased out as a gasoline additive.

Alcohols, particularly ethanol and less commonly, methanol, are now being used as the most common oxygenate. In many places, standard pump gasoline may comprise up to 10% vol. ethanol. Ethanol raises the octane rating of gasoline, thereby making it less susceptible to auto-ignition. Accordingly, standard pump gasoline comprising alcohols is more difficult to use in compression ignition engines.

### BRIEF SUMMARY OF EMBODIMENTS OF THE INVENTION

According to various embodiments of the invention, a fuel system is provided that includes a catalytic reactor that is configured to partially oxidize a portion of hydrocarbons in a hydrocarbon based fuel, which can contain oxygenated species, to create a fuel that is more compression ignitable. Exhaust gas is diverted from the exhaust system of an automobile and mixed with a hydrocarbon fuel. The fuel/exhaust gas mixture is exposed to an oxidizing catalyst such that at least a portion of the hydrocarbon fuel is partially oxidized. The resultant fuel mixture is metered into a compression ignition engine for engine operation.

According to an embodiment of the invention, an oxidation catalyst device comprises a housing configured to be installed into a fuel system for an automotive engine; and a catalytic material disposed within the housing. When installed in the fuel system, the oxidation catalyst device is in fluid communication with a fuel injection system and a fuel tank configured to store a hydrocarbon fuel, the oxidation catalyst device is configured to receive a mixture of the fuel from the fuel tank and a gas comprising an oxidant, the oxidation catalyst device is configured to partially oxidize at least a portion of the hydrocarbon fuel to form an output fuel, and the oxidation catalyst device is configured to provide the output fuel to the fuel injection system.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a fuel system implemented in accordance with an embodiment of the invention.

FIG. 2 illustrates a hydrocarbon fuel oxidation and oxygenate dehydration catalytic fuel system implemented in accordance with an embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for processing a hydrocarbon fuel in an automotive fuel system to form a partially oxidized hydrocarbon fuel. The partially oxidized hydrocarbon fuel comprises a hydrocarbon fuel having hydrocarbons that have been at least partially oxidized. This oxidized fuel is more susceptible to compression ignition than the original non-oxidized fuel.

The exhaust of an internal combustion engine, such as a compression ignition engine, contains many oxygen containing compounds. For example, exhaust gas may include oxygen (O₂), water, carbon monoxide, carbon dioxide, nitrous oxide, nitrogen dioxide, nitric oxide, sulfur dioxide, etc. Some or all of these oxygen containing compounds may react with various hydrocarbons in a hydrocarbon fuel to produce partially oxidized hydrocarbons, especially in the presence of certain catalysts.

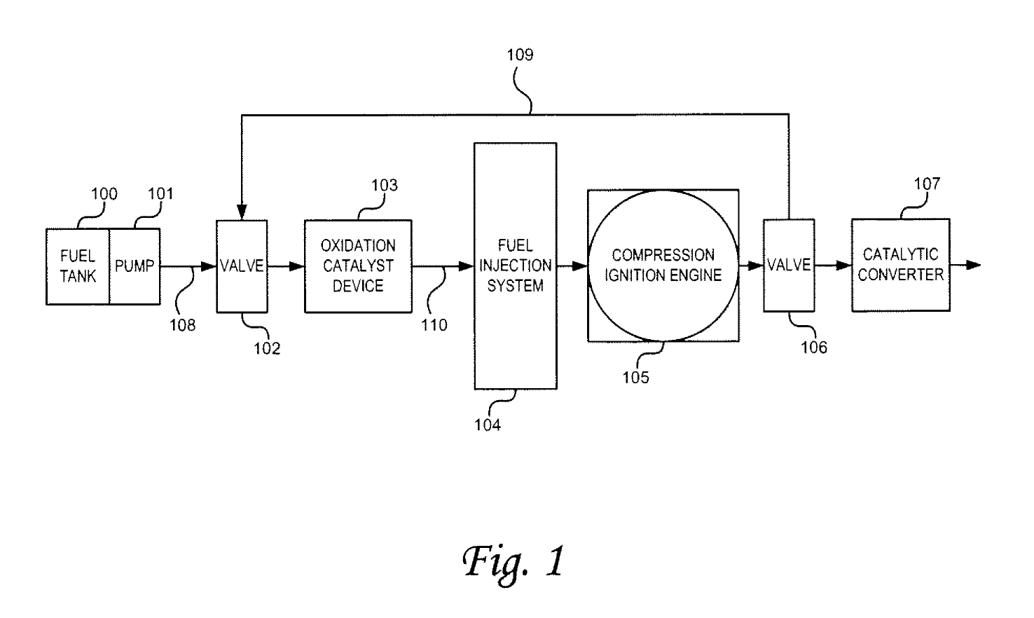

FIG. 1 illustrates a fuel supply system implemented in accordance with an embodiment of the invention. The fuel system is adapted to supply fuel to an engine 118 that is configured to operate in a compression ignition mode for at least a portion of its operating range. The fuel system comprises a fuel tank 100 configured to store a standard hydrocarbon fuel 108. In various embodiments, the hydrocarbon fuel 108 may comprise gasoline or diesel fuel. In embodiments where fuel 108 is gasoline, the gasoline may comprise a petroleum derived liquid mixture taken from approximately 200° C. and below during distillation and blended from the variety of chemical processes that are typically performed in the oil industry and includes additional standard chemical additives. Similarly, where fuel 108 is diesel, the diesel may comprise a petroleum derived liquid mixture taken from approximately 200° C. to 350° C. during distillation and blended from the variety of chemical processes that are typically performed in the oil industry, including additional standard chemical additives. The hydrocarbon fuel may also include other hydrocarbon based fuels that are available as fuels at conventional automotive fuel stations. Such hydrocarbon based fuels may include synthetic gasolines or diesels (such as liquefied coal or natural gas based fuels), biofuels such as biodiesel, ethanol fuel blends (such as E85 ethanol gasoline blend), mixtures thereof, or other similar hydrocarbon-based fuels.

Particularly, fuel 108 contains some proportion of hydrocarbons other than straight-chain paraffin hydrocarbons (“branched and unsaturated hydrocarbons”). For example, fuel 108 may contain aromatics, cyclic hydrocarbons, branched hydrocarbons, or other unsaturated hydrocarbons. These branched and unsaturated hydrocarbons are typically less susceptible to compression ignition than their straight-chain paraffin counterparts. For example, the autoignition temperature of n-heptane is 215° C., while the autoignition temperature of toluene is 530° C. This is also observed in the difference in n-heptane and toluene's Research Octane Numbers (RON), n-heptane being 0 and toluene being 120. This can be described by the bond dissociation energy and stability of the resulting radicals from n-heptane and toluene. Toluene's methyl group has a weaker carbon-hydrogen bond than n-heptane, therefore it is broken easier and initiates a step of combustion. However, the next combustion step requires oxygen to react with the resulting radicals formed from the carbon-hydrogen dissociation and here the radical formed from n-heptane is much more reactive and increases ease of ignition. Additionally, stories may influence combustion, molecules like n-heptane, with less steric hinderence, may increase an ease of ignition (toluene has much more crowding of neighboring groups. This is shown by the difference of toluene and n-heptane's auto-ignition temperature, where n-heptane ignites at 223° C. while toluene does so at 536° C.

Many oxygen containing species of non-linear hydrocarbons are often more compression ignitable than their non-oxidized counterparts. Using toluene as an example, toluene may be partially oxidized to form benzaldehyde, which is more compression ignitable than toluene. For example, benzaldehyde's autoignition temperature is 192° C. In addition, the precursor to benzaldehyde, benzyl alcohol has an autoignition temperature slightly lower than that of toluene, i.e. 536° C.

In the illustrated embodiment, the fuel tank 100 is in fluid communication with an oxidation catalyst device 103. The fuel pump 101 pressurizes the fuel system and pumps the fuel 108 into the oxidation catalyst device 103. Additionally, exhaust gas 109 is introduced to the fuel line upstream of the catalyst device 103, for example, using control valve 102. The introduction of the exhaust gas 109 forms a heterogeneous fuel/exhaust mixture that is introduced to a catalytic environment in the catalyst device 103. In other embodiments, rather than mixing the exhaust gas 109 and fuel upstream of the catalyst device 103, the exhaust gas 109 may be introduced directly to the device 103 and a heterogeneous fuel/exhaust mixture may be formed directly in the device 103 in the presence of a catalyst or before being introduced to a catalyst.

In some embodiments, the exhaust gas 109 comprises exhaust removed from the engine exhaust system upstream of the catalytic converter 107, for example, using a second control valve 106. In other embodiment, the exhaust gas 109 may be removed from an exhaust gas recirculation system. However, as discussed below, higher temperatures for the exhaust gas mixed with the fuel may be beneficial to the partial oxidation of the fuel 108. Accordingly, if the exhaust gas is removed from an exhaust gas recirculation system, typically it will be removed upstream of any heat exchangers that would otherwise remove heat from the gas 109.

In further embodiments, air from the external environment (“fresh air”) may be introduced into the fuel 108 rather than exhaust gas or in addition to exhaust gas. FIG. 3 illustrates an embodiment of the invention where fresh air 114 is introduced from the air intake system 113. In this embodiment, the fresh air may be used to increase the amount of oxygen in the mixed gas presented to the oxidation catalyst device 103. In further embodiments, the composition of the total air amount, (fresh air 114 plus exhaust gas 109) may be variable. For example, the amount of fresh air may vary from 0 to 100% of the total air amount. In various embodiments, the ratio of fresh air 114 to exhaust gas 109 may be fixed for a particular engine, or variable. For example, in a variable configuration, the ratio may be controllable by the engine's engine control unit (ECU) as a parameter in the ECU's look up table.

The oxidation catalyst device 103 comprises a chemical reactor containing an oxidation catalyst. In various embodiments, oxidation catalysts may include transition metal oxides, perovskites, zeolites, zeotypes, noble metals, vanadium phosphorous oxides, mixed metal oxides, alkali metals, alkaline metals, rare earth metals, transition metals including the noble metals and coinage metals, heteropoly acids or polyoxometalates, aluminas, metal substituted zeolites, silicoaluminum phosphates, aluminum phosphates, mesoporous materials or other oxidation catalysts. The catalyst material may be maintained in the device 103 through a variety of methods. For example, the catalyst form may comprise a pellet or extrudate of the catalyst material (with or without a binder), a catalyst material supported by an inert carrier (such as alumina, silica, or other carrier), a catalyst supported by a metal or ceramic monolithic substrate, or a coating of the catalyst material on a surface of a metal or ceramic part (for example a foam substrate).

In the illustrated embodiment, the hydrocarbon fuel 108 undergoes partial oxidation inside the catalyst device 103 to form a partially oxidized fuel 110. In some embodiments, the non-linear hydrocarbon components of the hydrocarbon fuel 108 may be more readily oxidized than the straight chain paraffin hydrocarbons of the hydrocarbon fuel 108. Accordingly, in these embodiments, the partial oxidation in the catalyst device 103 may have a targeting effect, where non-linear hydrocarbons might be oxidized into more compression ignitable species while the straight chain paraffins (which are already susceptible to compression ignition) are not reacted.

The increase in compression ignitability between the partially oxidized fuel 110 and the fuel 108 is dependent on many parameters, such as catalyst reactor volume, type of catalyst, amount of catalyst, catalyst support type, catalytic surface area, temperature of the reactor, amount of exhaust gas 109 mixed into the fuel 108, chemical makeup of the fuel 108, and available oxygen in the exhaust gas 109. Some of the parameters are fixed for particular applications. For example, a compression ignition engine designed to operate on gasoline will often have a substantially constant fuel makeup 108. Or, if the fuel makeup 108 varies, the fuel system may be designed to accommodate the least compression ignitable makeup that the engine is likely to be operated under.

Other parameters may be adjusted during design and manufacture of the fuel system, such as catalytic material related parameters like the amount, size, support type, surface area of the catalyst. These parameters may be set based on engine parameters, such as the size of the engine being used and the desired amount of conversion based on the typical operating conditions of this engine. For example, compression ignition is often more stable under higher loads than lower loads. Accordingly, the catalyst parameters may be set based on specific load conditions, i.e. sufficient conversion under low loads or high loads. Additionally, temperature parameters may be set by attaching heat sinks or heaters that are configured to maintain the device 103 at a preferred temperature or within a preferred temperature range for oxidation.

In still further embodiments, various parameters may be adjustable during engine operation. For instance, the engine control system may adjust certain parameters based on specific fuel type (for example, for winter or summer fuel blends) for engine starting conditions versus stable engine operation conditions, or for different engine load conditions. By way of example, the amount of exhaust gas mixed with the fuel, or the temperature of the reactor may be adjusted during engine operation. These variations may serve to adjust the conversion amounts within the range of conversion possibilities set by the specific system to achieve compression ignitibility over a range of operating conditions.

As discussed above, in some embodiments air may be mixed with the fuel 108 rather than exhaust gas 109. However, in many embodiments, the use of exhaust gas 109 is preferred. For example, the use of exhaust gas 109 may maintain the temperature at a preferred level without the use of heating elements and the use of exhaust may introduce water and carbon dioxide or other beneficial compounds into the fuel. In some cases, water or carbon dioxide may have solvation effects on the fuel, that may decrease temperature requirements of the fuel system or give fuel injection benefits.

As discussed above, the catalyst device 103 forms partially oxidized fuel 110. The partially oxidized fuel 110 comprises a fuel having at least a portion of its hydrocarbon content converted into oxygen-containing hydrocarbon species. Particularly, at least a portion of the in fuel 108 is at least partially oxidized to form oxygen-containing species that are more compression ignitable than their non-oxidized precursors. After this fuel 110 is formed by the device 103, it is pumped into a fuel injection system 104 and metered into compression ignition engine 105. A portion of the resultant exhaust gas 109 is fed back into the fuel system using valves 106 and 102, while the remaining exhaust proceeds through the rest of the exhaust system.

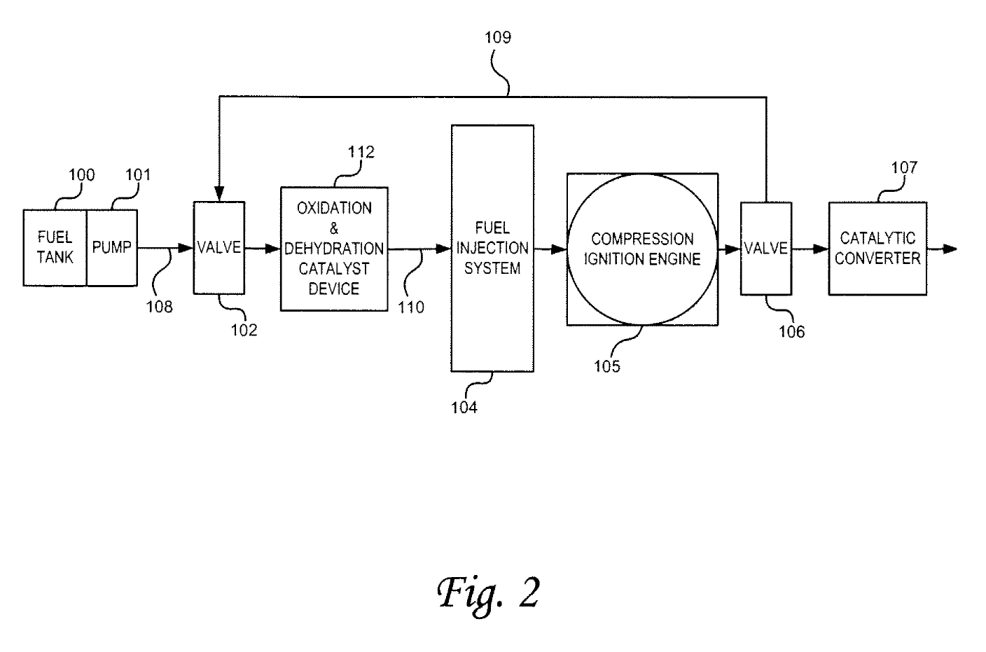

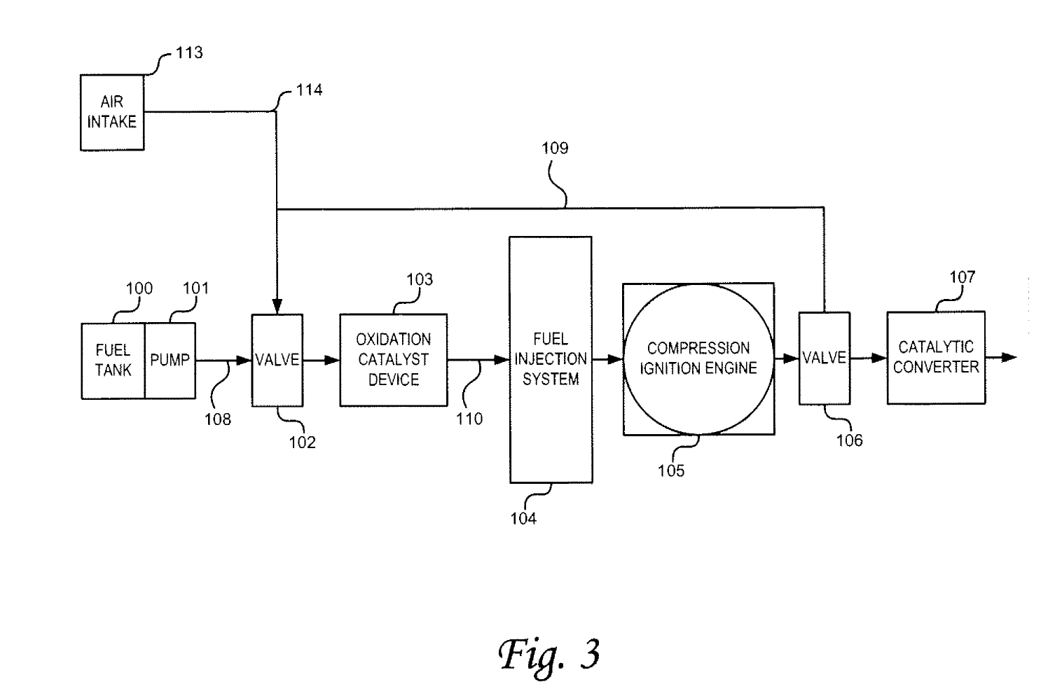

In further embodiments, the hydrocarbon oxidation catalyst system may be combined with a dehydration catalyst system that is configured to dehydrate alcohol-based oxygenates also present in the fuel. One such system is illustrated in FIG. 2, A dehydration catalyst device may be configured to dehydrate a portion of the alcohol oxygenate content in a fuel to form an ether containing fuel. Such dehydration catalyst devices may contain catalytic materials such as H-Ferrierite, H-ZSM-5, H-Beta, H-SAPO-34 catalyst, Alumina, modified Aluminas i.e. Halide treated Alumina, Silica-Alumina, Metal-Modified Zeolites i.e. Sodium modified ZSM-5, Metal substituted zeolites i.e. Boron incorporated ZSM-5, Silicoaluminum Phosphates i.e. SAPO-34, Modified Silicoaluminum Phosphates i.e. Cobalt doped SAPO-34, Aluminum Phosphates i.e. ALPO-18, Modified Aluminum Phosphates i.e. Cobalt incorporated ALPO-18, Acidic Mesoporous Materials i.e. Si-MCM-41, Ion exchange resins i.e. Nafion, Polysulfonated resins i.e. Amberlyst 15, Solid Phosphoric Acid, Supported Mineral Acids i.e. Boric acid on diatomaceous earth, Heteropoly acids i.e. Silicotungstic acid, Supported Heteropoly acids i.e. Silicotungstic acid on SBA-15, Sulfonated Zirconia, Metal Oxides, Mixed Metal Oxides i.e. Titanium dioxide—Zirconium dioxide, Supported acids i.e. Antimony Pentafluoride on Silica-Alumina, Pillared Interlayered Clays, or Liquid Catalysts i.e. Sulfuric Acid, or combinations thereof.

Many of the catalysts may also be used as hydrocarbon oxidizing catalysts, or may serve as supports for oxidizing catalysts. In the embodiment illustrated in FIG. 2, the catalyst device 110 comprises an oxidation catalyst as described above and a dehydration catalyst device. In this embodiment, fuel 110 further comprises an ether-containing fuel and a partially oxidized hydrocarbon containing fuel.

In still further embodiments, multiple catalytic reactors may be incorporated into the fuel system. For example, a dehydration catalyst may be placed upstream or downstream of the oxidation catalyst such that the final fuel provided to the fuel injection system 104 comprises an ether-containing fuel and a partially oxidized hydrocarbon containing fuel.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A fuel system for an automotive engine, comprising:
an oxidation catalyst device in fluid communication with a fuel injection system and a fuel tank configured to store a hydrocarbon fuel;
wherein the oxidation catalyst device is configured to receive a mixture of the fuel from the fuel tank and a gas comprising an oxidant;
wherein the oxidation catalyst device is configured to partially oxidize at least a portion of the hydrocarbon fuel to form an output fuel; and
wherein the oxidation catalyst device is configured to provide the output fuel to the fuel injection system.

2. The fuel system of claim 1, wherein the gas comprises exhaust gas.

3. The fuel system of claim 2, wherein the oxidation catalyst device is configured such that the output fuel is usable in a compression ignition engine at a predetermined engine load.

4. The fuel system of claim 3, wherein the oxidation catalyst device is configured such that the output fuel is usable in the compression ignition engine over a range of predetermined engine loads.

5. The fuel system of claim 3, wherein the oxidation catalyst device has a predetermined conversion rate configured such that the portion of hydrocarbon fuel that is partially oxidized is sufficient to allow the output fuel to be used in a compression ignition engine at a predetermined load condition.

6. The fuel system of claim 2, further comprising:
a fuel pump disposed between the fuel tank and the oxidation catalyst device and configured to maintain a predetermined fuel pressure in the oxidation catalyst device; and
an exhaust gas line in fluid communication with exhaust gas downstream of the compression ignition engine and upstream of a catalytic converter and configured to provide the exhaust gas to the fuel system upstream of the oxidation catalyst device. And a fresh air source.

7. The fuel system of claim 1, wherein the oxidation catalyst device comprises a catalytic material comprising transition metal oxides, perovskites, zeolites, zeotypes, noble metals, vanadium phosphorous oxides, mixed metal oxides, alkali metals, alkaline metals, rare earth metals, transition metals, heteropoly acids or polyoxometalates, aluminas, metal substituted zeolites, silicoaluminum phosphates, aluminum phosphates, mesoporous materials or other oxidation catalysts.

8. The fuel system of claim 7, wherein the catalytic material comprises a pellet or extrudate, wherein the catalytic material is supported by an inert carrier, wherein the catalytic material is supported by a metal or a ceramic monolithic structure, or wherein the catalytic material is a coating on a surface a metal, a ceramic part, or a foam substrate.

9. The fuel system of claim 1, wherein the oxidation catalyst device is configured to preferentially oxidize hydrocarbons other than straight-chain paraffin hydrocarbons.

10. An oxidation catalyst device, comprising:
a housing configured to be installed into a fuel system for an automotive engine; and
a catalytic material disposed within the housing;
wherein, when installed in the fuel system:
the oxidation catalyst device is in fluid communication with a fuel injection system and a fuel tank configured to store a hydrocarbon fuel;
the oxidation catalyst device is configured to receive a mixture of the fuel from the fuel tank and a gas comprising an oxidant;
the oxidation catalyst device is configured to partially oxidize at least a portion of the hydrocarbon fuel to form an output fuel; and
the oxidation catalyst device is configured to provide the output fuel to the fuel injection system.

11. The oxidation catalyst device of claim 10, wherein the gas comprises exhaust gas.

12. The oxidation catalyst device of claim 11, wherein the oxidation catalyst device is configured such that the output fuel is usable in a compression ignition engine at a predetermined engine load.

13. The oxidation catalyst device of claim 12, wherein the oxidation catalyst device is configured such that the output fuel is usable in the compression ignition engine over a range of predetermined engine loads.

14. The oxidation catalyst device of claim 12, wherein the oxidation catalyst device has a predetermined conversion rate configured such that the portion of hydrocarbon fuel that is partially oxidized is sufficient to allow the output fuel to be used in a compression ignition engine at a predetermined load condition.

15. The oxidation catalyst device of claim 10, wherein the oxidation catalyst device comprises a catalytic material comprising transition metal oxides, perovskites, zeolites, zeotypes, noble metals, vanadium phosphorous oxides, mixed metal oxides, alkali metals, alkaline metals, rare earth metals, transition metals, heteropoly acids or polyoxometalates, aluminas, metal substituted zeolites, silicoaluminum phosphates, aluminum phosphates, mesoporous materials or other oxidation catalysts.

16. The oxidation catalyst device of claim 15, wherein the catalytic material comprises a pellet or extrudate, wherein the catalytic material is supported by an inert carrier, wherein the catalytic material is supported by a metal or a ceramic monolithic structure, or wherein the catalytic material is a coating on a surface a metal, a ceramic part, or a foam substrate.

17. The oxidation catalyst device of claim 10, wherein the oxidation catalyst device is configured to preferentially oxidize hydrocarbons other than straight-chain paraffin hydrocarbons.

18. A method of supplying fuel to a compression ignition engine, comprising:
forming a mixture from a hydrocarbon fuel and a gas, wherein the gas comprises an oxidant;
providing the mixture to a catalytic material;
partially oxidizing at least a portion of the hydrocarbon fuel in the presence of the catalytic material to from an output fuel; and
providing the output fuel to a fuel injection system.

19. The method of claim 18, wherein the gas comprises exhaust gas.

20. The method of claim 19, wherein the catalytic material is configured such that the output fuel is usable in the compression ignition engine at a predetermined engine load.

21. The method of claim 20, wherein the catalytic material is configured such that the output fuel is usable in the compression ignition engine over a range of predetermined engine loads.

22. The method of claim 20, wherein the catalytic material has a predetermined conversion rate configured such that the portion of hydrocarbon fuel that is partially oxidized is sufficient to allow the output fuel to be used in a compression ignition engine at a predetermined load condition.

23. The method of claim 19, wherein the exhaust gas is removed downstream of the compression ignition engine and upstream of a catalytic converter and wherein the fuel is pumped from a fuel tank such that a predetermined fuel pressure is maintained in the presence of the catalytic material.

24. The method of claim 18, wherein the catalytic material comprises transition metal oxides, perovskites, zeolites, zeotypes, noble metals, vanadium phosphorous oxides, mixed metal oxides, alkali metals, alkaline metals, rare earth metals, transition metals, heteropoly acids or polyoxometalates, aluminas, metal substituted zeolites, silicoaluminum phosphates, aluminum phosphates, mesoporous materials or other oxidation catalysts.

25. The method of claim 24, wherein the catalytic material comprises a pellet or extrudate, wherein the catalytic material is supported by an inert carrier, wherein the catalytic material is supported by a metal or a ceramic monolithic structure, or wherein the catalytic material is a coating on a surface a metal or a ceramic part.

26. The method of claim 18, wherein the catalytic material is configured to preferentially oxidize hydrocarbons other than straight-chain paraffin hydrocarbons.
